(19) United States
(12) Patent Application Publication
(10) Pub. No.: US 2003/0067774 A1
(43) Pub. Date: Apr. 10, 2003

(54) Illumination systems and methods employing diffractive holographic optical elements

(75) Inventor: Todd E. Lizotte, Manchester, NH (US)

Correspondence Address: SCOTT C. RAND, ESQ., MCLANE, GRAF, RAULERSON & MIDDLETON, PA, 900 ELM STREET, P.O. BOX 326, MANCHESTER, NH, 03105-0326, US

(73) Assignee: NANOVIA, L.P.

(21) Appl. No.: 10/262,127

(22) Filed: Oct. 1, 2002

Related U.S. Application Data
(60) Provisional application No. 60/327,210, filed on Oct. 4, 2001.

(51) Int. Cl. F21V 1/00

(52) U.S. Cl. 362/236; 362/235; 362/317; 362/19

(57) ABSTRACT

In one aspect, an illumination device for illuminating a desired portion of a target object includes a light source and one or more diffractive, holographic optical elements disposed in an optical path between said light source and the target for forming a discrete illumination field on the target. In a further aspect, a method for illuminating a desired portion of a target object to be illuminated includes providing a source of light and arranging a diffractive, holographic and diffractive optical element in an optical path between said source of light and said target. The optical element is configured to deliver a selected pattern of light to an illumination field at a selected working distance away from the combined holographic and diffractive optical element. A target object to be illuminated is positioned in the optical axis at a distance approximately equal to said working distance.

### CROSS-REFERENCE TO RELATED APPLICATION

This application claims the benefit under 35 U.S.C. § 119(e) of U.S. provisional application Serial No. 60/327,210 filed Oct. 4, 2001. Said provisional application is incorporated herein by reference in its entirety.

### BRIEF DESCRIPTION OF THE DRAWINGS

In the accompanying drawings:

FIG. 1 is a cross-sectional view of an exemplary ring illuminator according to one aspect of the present invention;

FIG. 2 is a perspective view of the ring illuminator shown in FIG. 1;

FIG. 3 is an exploded view of the ring illuminator shown in FIGS. 1 and 2;

FIG. 4 is a fragmentary view of the ring illuminator shown in FIGS. 1-3;

FIG. 5 is a perspective view of a generally donut-shaped hybrid diffractive and holographic optical element with a pattern type;

FIG. 6 illustrates a sleeve incorporating an optical element in accordance with a further aspect of the present invention;

FIGS. 7 and 8 illustrate an illumination system operable for both machine vision alignment and photo-induced bonding applications;

FIG. 9 is an enlarged, fragmentary view of the combined illumination/photocuring system of FIGS. 7 and 8;

FIG. 10 shows an off-axis illuminator in accordance with yet a further aspect of the present invention including a beam splitter and hybrid diffractive and holographic optical element; and

FIG. 11 shows a dual-sided hybrid HOE element for use with the present invention.

### DESCRIPTION OF EMBODIMENTS

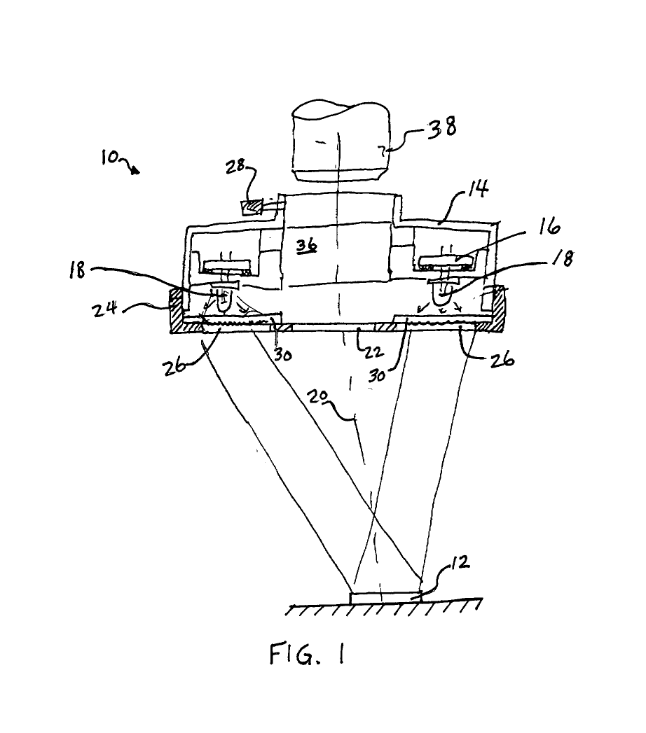

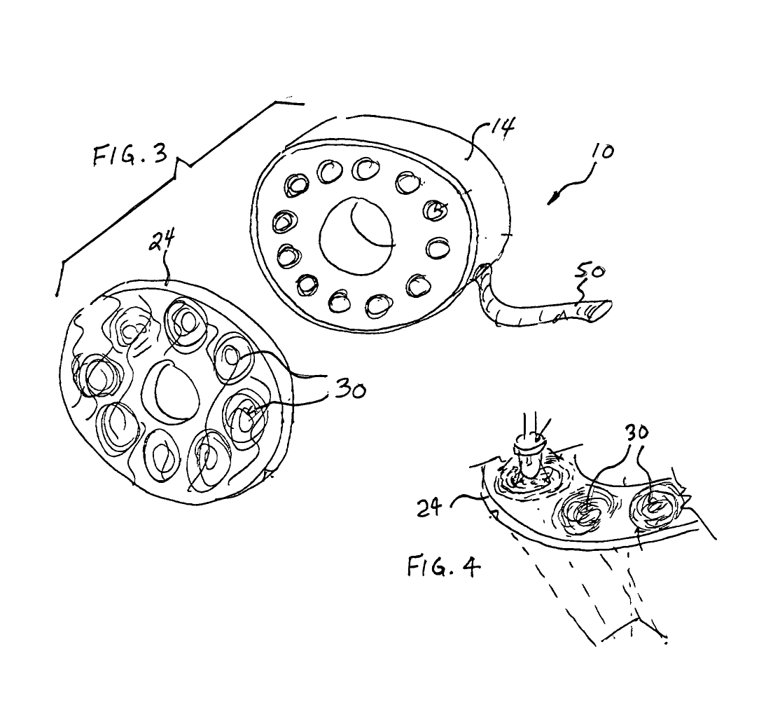

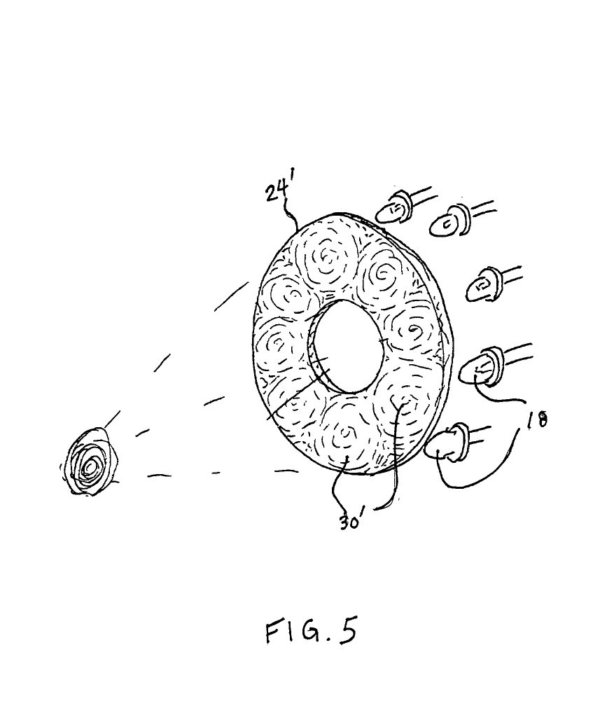

With reference to FIGS. 1-4, there is shown an exemplary ring illumination device 10 according to the present invention for illumination an object 12 to be observed, inspected, imaged, or the like. Exemplary surfaces 12 to be illuminated include, but are not limited to, circuit boards, integrated circuits, fiber optic devices, micro electro mechanical systems (MEMS), micro optic assemblies, and so forth.

The present device finds utility in structuring light into a desired shape such as a geometric shape and directing the light to a desired location to produce a uniform or pseudo-uniform illumination field on an area of the surface to optimize illumination for all manner of viewing applications including, but not limited to, machine vision applications, imaging applications, human visual inspection, reading bar codes or other machine readable code, characters and so forth, applications involving high-speed strobe inspection of moving products along a production line, spectroscopic applications, manual or automated alignment or orientation of objects prior to processing, handling, machining, bonding, imaging and so forth, metrology, machine alignment, matching recognition, fiducial recognition and alignment, object recognition and inspection applications, and like applications.

The device 10 includes an upper housing shell 14 and a base housing shell 24 adapted to house and/or support the other components of the invention. A fastener 28, such as a set screw, clamp, or the like, is provided on the housing to aid in positioning the device 10. A printed circuit board 16 is electrically coupled to a power source 50 or other power source such as a battery power source and has mounted thereon a plurality of light or illumination sources 18 radially spaced about an optical axis 20.

Although the light sources 18 are depicted in the exemplary embodiment as light emitting diodes, it will be recognized that any other light source may be utilized, including but not limited laser light sources, diode lasers, organic light emitting diodes (OLEDs), incandescent lamps, and so forth. The light sources 18 may be monochromatic or broad spectrum, uniform or nonuniform in intensity profile, dispersive or collimated, coherent or noncoherent, etc.

The light sources 18 may be of the same wavelength or different wavelengths. For example, multiple wavelengths of illumination may be provided within a single illumination ring or array which may be selectively turned on and off to provide selectable wavelengths for different illumination activities or applications.

In an alternative embodiment, the light sources may be located remotely of the device 10, e.g., wherein one or more light sources are directed to the plurality of radially spaced apart positions via optical fiber(s), or the like.

Although the light sources 18 are depicted as a circular array, it will be recognized that arrays of any configuration or shape may be employed, such as rectangular or other geometric shape, or any other desired shape or pattern.

The base 24 includes a plurality of openings 26 radially spaced apart about an opening 22 centered about the optical axis 20, each in alignment with an adjacent light source 18. The housing of the device 10 supports diffractive optics comprising a plurality of individual holographic optical elements (HOEs) 30 disposed at each aperture 26.

Although the present invention will be described in reference to the preferred embodiments wherein the diffractive optics comprise individual holographic elements, e.g., that are computer generated, it will be recognized that diffractive Fresnel zone plate designs that mimic standard geometric optics, with the added attributes of being able to direct the beam at specific angles to illuminate a desired target region, may also be employed.

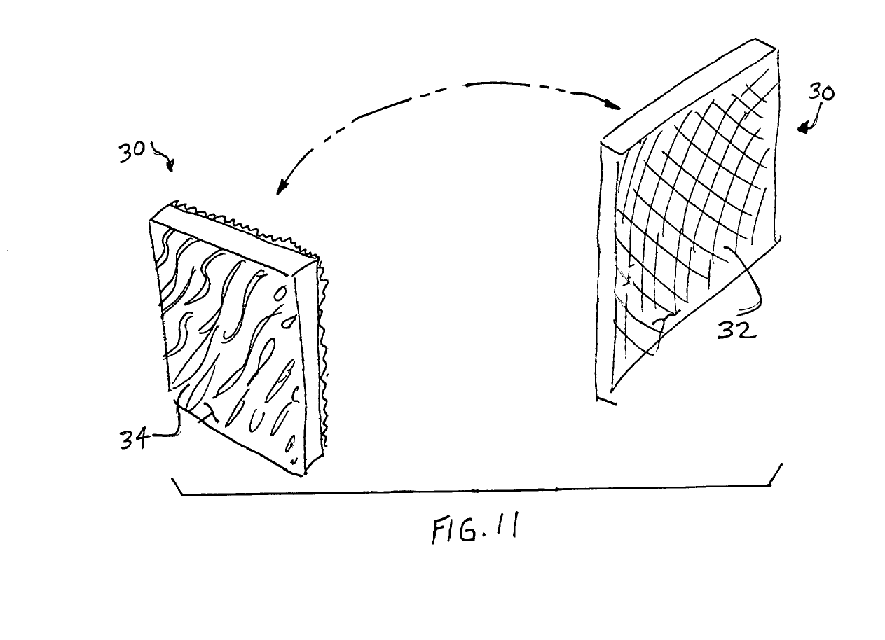

In certain embodiments, hybrid diffractive and holographic optical elements 30 are contemplated. Referring now to FIG. 11, a hybrid optical element 30 operable to embody the present invention includes a diffractive zone plate design or pattern formed on a first surface 32 of the element 30 and hologram such as a computer-generated hologram formed on a second surface 34 of the element 30 opposite the first surface. Alternatively, in still other embodiments, the hologram and diffractive pattern can be combined onto a single surface of the element 30.

With continued reference to FIGS. 1-4, each HOE 30 receives light from the light source 18 and directs and shapes the light beam onto the target 12, thereby providing uniform illumination of the target 12 from multiple directions. Depending on the particular application, the HOE 30 may be a commercially available optical element, or, may be customized to a particular application.

The HOE optical elements 30 are selected in accordance with specific working and intensity distribution requirements as dictated by the end use. The hybrid holographic diffractive optical element 30 incorporates computer-generated holographic and diffractive elements to form a selected illumination pattern or structure, e.g., a selected field size and working distance matched to a focal length or operational working distance of an optical visions system and/or the working distance of a light source used for photo curing of light-sensitive bonding materials.

Commercially available HOE optical elements may be employed in connection with the present invention, or, they may be created by standard or customized, computer-generated holographic/diffractive mathematical equations. The optical elements 30 may be formed from any optical material, selected to allow for transmission of the particular wavelengths of interest, such as gallium arsenide, gallium phosphide, germanium, zinc selenide, zinc sulfide, glass, fused silica, quartz, borosilicate glass (e.g., Pyrex®), polymeric materials such as Lexan®, polycarbonate, and the like. The elements 30 may be formed via any process for creating the desired surface relief pattern, including, for example, standard semiconductor lithography and etching techniques, embossing, molding techniques, such as injection molding, and so forth.

The elements 30 are selected to tailor the light to a selected or desired beam shape, profile, direction, and working distance onto a selected target 12. In a preferred embodiment, the optical elements 30 are removable and may be exchanged for use with multiple applications.

In certain embodiments, the present invention may be achieved by replacing the standard diffusion optics of a conventional ring illumination with the HOE elements 30 in accordance with the present invention. Alternatively, the HOE elements 30 are employed with a customized light source.

In the depicted embodiment, the device 10 further includes a central opening or aperture 36 aligned with the optical axis 20 of viewing optics 38, which receives light reflected from the object 12 to be imaged, inspected, etc. The viewing optics 38 may include, for example, a camera, video camera, CCD array, film camera, digital camera, microscope, photomultiplier tube array, or other photosensitive array.

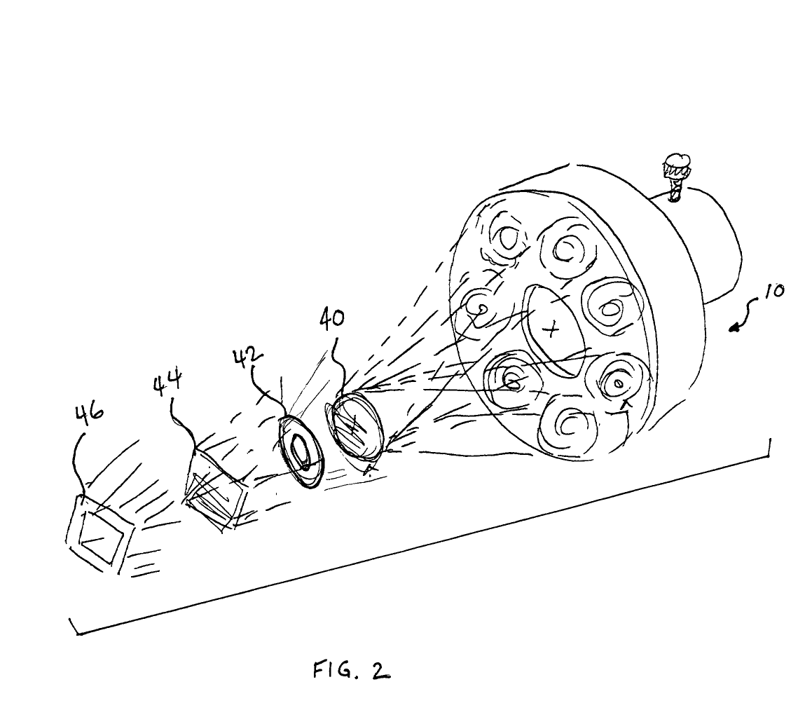

The illumination field provided by the present invention can be formed into specialized shapes and specified working distances away from the HOE 30 array. With specific reference to FIG. 2, there appears some exemplary illumination shapes which may be achieved employing the illumination device in accordance with the present invention. Exemplary embodiments include circular- or disc-shaped (40), ring-shaped (42), rectangular (44), and rectangular ring-shaped (46), illumination patterns. However, it will be recognized that virtually any geometric shape, irregular shapes, or regular or irregular discontinuous pattern may be achieved by the present invention. Likewise, for any pattern, a desired intensity profile may be achieved, i.e., uniform or pseudo uniform (or some otherwise desirable intensity profile). For example, the beam shape and intensity profile may be selected to provide optimum illumination for specific machine vision, photo bonding, or other applications.

In certain embodiments, the formation of a discontinuous pattern of structured light allows the simultaneous illumination of several specific sites, such as several specific sites within the field of view of a vision system for inspection, or, for allowing the photo curing of light activated adhesives and/or bonding agents at specific positions over a part or parts of a device to be bonded.

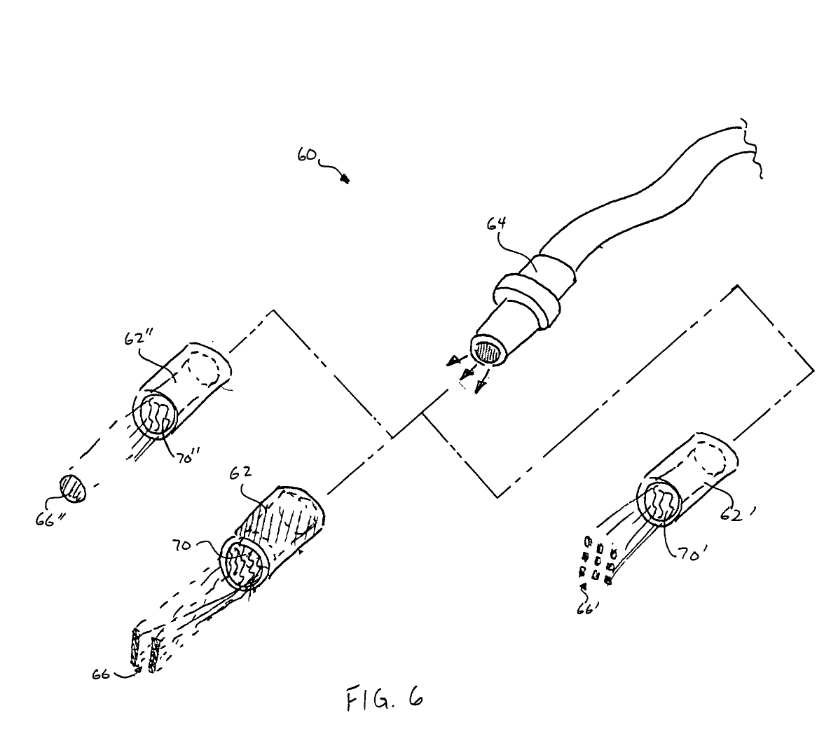

With reference now to FIG. 5, there is shown an alternative embodiment in which the HOE elements 30′ are integral with a base portion 24′, and which may be interchanged with the base housing portion 24 and elements 30 of FIGS. 1-4. For example, the base plate 24′ may be formed of a polymeric or other optical material with the elements 30′ stamped, etched, or molded directly thereon. In the same manner as described above by way of reference to FIGS. 1-4, the integral base 24′ and elements 30′ the base plate 24′ may optionally have a diffractive pattern and a holographic pattern disposed on opposing sides thereof, or, optionally, hologram and diffractive patterns may be superimposed on a single surface of the base plate 24′.

With reference to FIGS. 1-5, it may be desirable to observe and/or image fluorescent emission from the target object 12. In such cases, a spectral filter can optionally be provided along the optical axis 20 which blocks the laser illumination light wavelength and which passes the fluorescent emission light to the viewing optics 38.

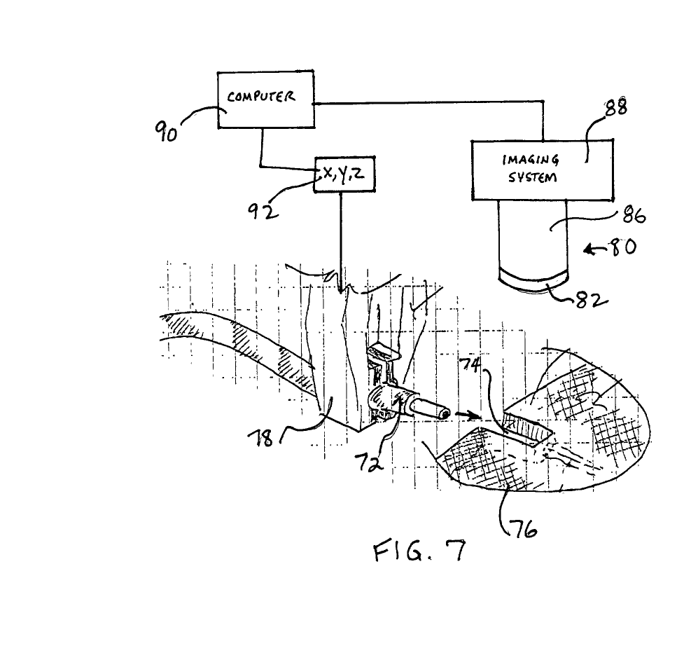

Referring now to FIG. 6, a beam-shaping or wave front enhancement device 60 in accordance with a further aspect of the present invention includes a sleeve 62 that is incorporated or slipped onto the end of an illumination source 64 to structure light from the source 64 into a desired illumination pattern 66 via a holographic optical element 68. In the depicted embodiment, the illumination source 64 is a fiber optic that is used to transport light, e.g., ultraviolet radiation for photo curing light-sensitive adhesives for bonding applications. The element 68 may be as described above by way of reference to the element 30 (FIGS. 1-4 and 11).

The sleeve 62 may be removably attached to the source 64 and exchanged to provide for different illumination fields and use in different applications. For example, in the illustrated embodiment, the sleeve 62 may be replaced with a sleeve 62′ or 62″, for example, having elements 68′ and 68″, respectively, to provide selected illumination fields 66′ and 66″, respectively. As set forth above, any geometric shape or irregular shape is contemplated, including rings or bands, continuous and discontinuous illumination fields, as well as various intensities and intensity profiles, angles, and working distances.

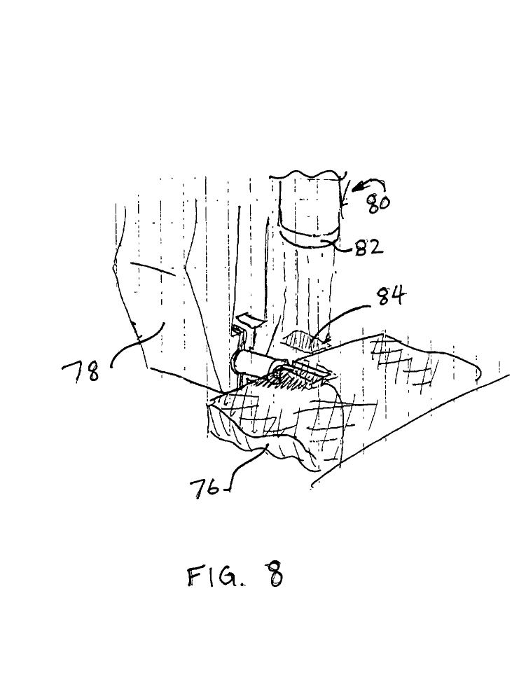

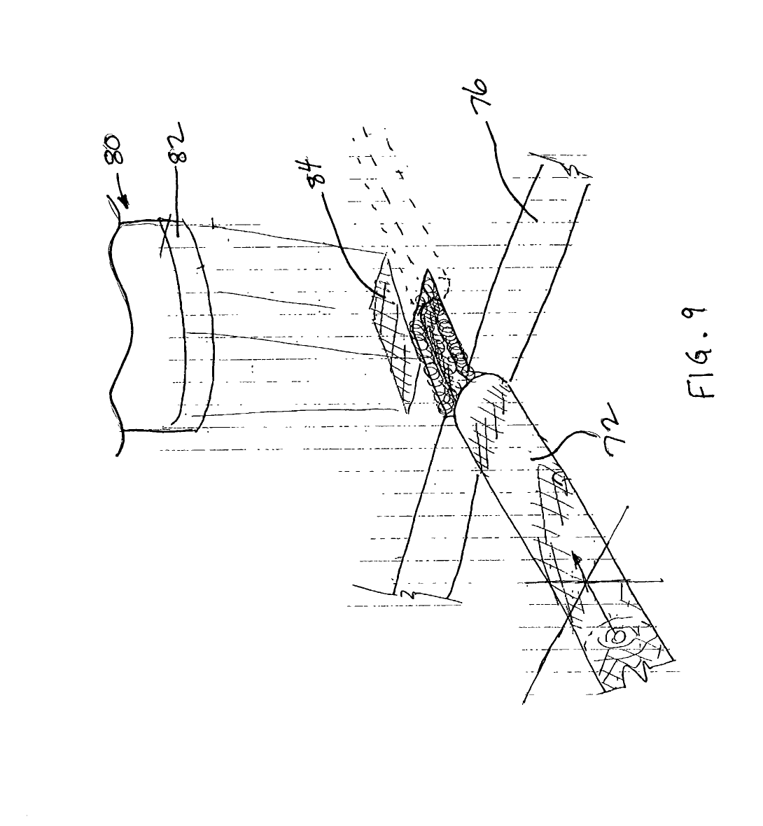

Referring now to FIGS. 7-9, a combined light curing and machine vision system 70 is shown which incorporates both imaging and photobonding operations into a single system which allows optimized illumination for precise vision inspection, alignment and subsequent photo bonding of components within the field of view of a camera scope system, e.g., on automated assembly or automated bonding system work piece. The light curing system 70 may be, for example, of a type used for bonding optical fiber 72 to a target region 74 of a waveguide material 76, such as a polymer or solid state waveguide devices, or, similar fiber optic bonding or fiber attachment processes used in the communications market.

The system 70 includes a gripper 78 which moves the fiber 72 within a field of illumination 84 shaped using an illumination device 80 incorporating a HOE element 82 in accordance with this teaching. In certain embodiments, the illumination device may be a ring illuminator incorporating HOE elements, such as ring illuminator as described above by way of reference to FIGS. 1-5. Alternatively, an illuminator employing a single light source is also contemplated.

The illumination device 80 may be used in conjunction with viewing optics 86 and imaging electronics 88 such as a camera, CCD or other photo sensor array, or the like, and a computer-based information handling system 90 for the automatic, optimal alignment of the fiber 72 to the waveguide substrate 74. Once the fiber 72 is optimally positioned, the illumination system 80 provides an optimized illumination field 84 to bond the fiber to the waveguide material, e.g., using a photo-sensitive or photo-activated adhesive or bonding materials.

The same wavelengths of light may be used for both the alignment and bonding operations. In preferred embodiments, the light source is an ultraviolet (UV) source, most preferably UV light in the range between about 150 nm to about 465 nm. Most preferably, the light source is a pulsed laser source with a pulse width ranging on the order of nanoseconds to milliseconds, depending on the radiation source.

When the illumination system 80 includes multiple light sources, such as a ring illuminator of a type detailed above, the machine vision optics may view the target along an optical axis passing centrally between the plural light sources. However, an illumination system 80 having a single illumination source is also contemplated, e.g., wherein the sensing optics are located adjacent to the light source and the HOE 82.

Light sources of differing wavelengths may be selectively employed for alignment purposes and for bonding purposes, e.g., wherein the light of an appropriate wavelength is selectively actuated by the computer system 90 under preprogrammed control.

In still a further embodiment, the illumination device 80 carrying the HOE 82 may be used solely for the bonding illumination and wherein the illumination used for the automatic alignment of the fiber 72 may use a separate light source, ambient lighting, etc. Likewise, the optics used for the automated alignment may be incorporated into or optically coupled to the illumination device 80 or may be separately located therefrom. Finally, in still another embodiment, the machine vision viewing optics may be optically coupled to the fiber 72 itself for the automated alignment, with the illumination device 80 providing the bonding illumination and, optionally, providing illumination for the machine vision alignment.

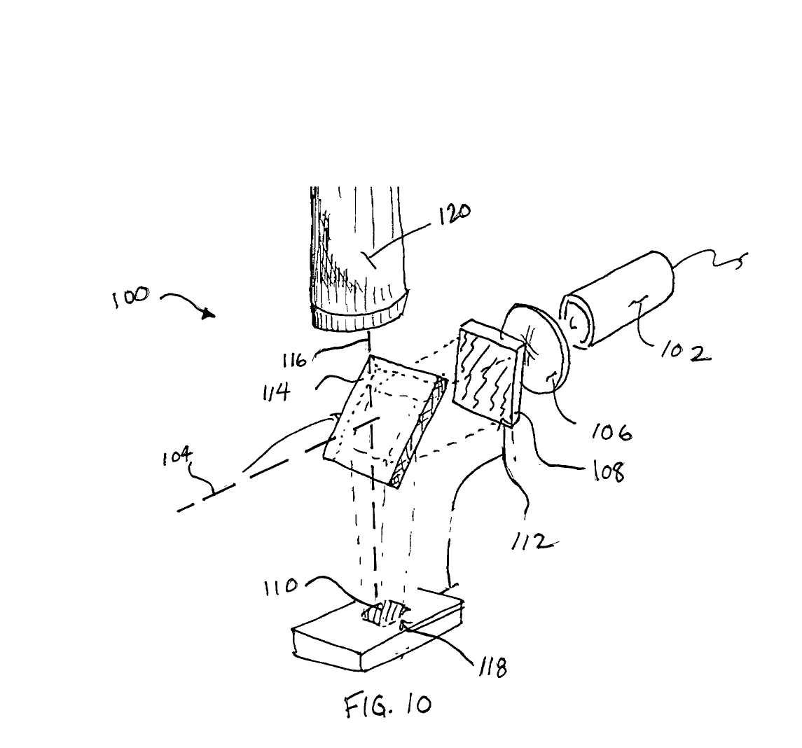

Referring now to FIG. 10, there appears an illumination system 100 according to yet a further embodiment of the present invention. A light source 102 such as a laser light source directs light along a first axis 104. A lens or other optical element 106 may be used to focus or expand the beam and/or to provide a collimated beam, etc., which is then transmitted to a HOE element 108 which is designed to produce a patterned or shaped illumination field 110 which is uniform or otherwise has desired intensity characteristics at a desired or selected operational working distance 112 therefrom. The HOE 108 may be as described above.

The beam producing the desired illumination field 112 is folded, e.g., 45 degrees, by a beam splitter, dichroic mirror, or the like 114, along an optical axis 116 onto the target object 118 to be illuminated. Viewing optics 120, such as a camera, microscope, etc., as described are used to view and/or image the illuminated target 118 along the optical axis 116.

With continued reference to FIG. 10, in certain embodiments wherein fluorescent emission from the target object 118 is to be observed, the beam splitter 118 may be a dichroic mirror which reflects and/or blocks passage of the incident radiation and which passes the fluorescence radiation. Additionally or alternatively, a spectral filter can optionally be provided along the optical axis 116 between the beam splitter 114 and the viewing optics 120 which blocks the laser illumination light and passes the fluorescent emission light to the viewing optics, e.g., for forming an image of the fluorescent emission.

Although the HOE in accordance with this teaching has been described in reference to transmissive optical elements, it will be understood that the reflective HOE optical elements can also be employed. For example, the optical elements can be coated to allow for reflection and still retain their diffractive properties. In cases where the illumination light source cannot be readily placed behind the HOE element, it will be understood that reflective configurations may be employed.

Likewise, it will be recognized that any further means of delivering or steering the light energy to the sample may be used, including prisms, mirrors, lenses, optical fibers, optical crystals, filters, and the like, and any arrangements, combinations, and/or equivalents thereof.

The invention has been described with reference to the preferred embodiment. Modifications and alterations will occur to others upon a reading and understanding of the preceding detailed description. It is intended that the invention be construed as including all such modifications and alterations.

Having thus described the preferred embodiments, the invention is now claimed to be:

1. An illumination device for illuminating a desired portion of a target object, comprising:
a light source;
one or more diffractive, holographic optical elements disposed in an optical path between said light source and the target for forming a discrete illumination field on the target.

2. The illumination device of claim 1, wherein the light source comprises a plurality of light sources radially spaced about a viewing axis passing through said target.

3. The illumination device of claim 2, further comprising:
a housing supporting said plurality of light sources and the one or more diffractive, holographic optical elements.

4. The illumination device of claim 3, wherein the housing comprises an opening axially aligned with said viewing axis.

5. The illumination device of claim 4, further comprising:
viewing optics for receiving light from the target passing through said opening in said housing.

6. The illumination device of claim 3, wherein said one or more diffractive, holographic optical elements are integrally formed with a portion said housing.

7. The illumination device of claim 3, wherein said one or more diffractive, holographic optical elements are removably attached to said housing.

8. The illumination device of claim 1, wherein the one or more diffractive, holographic optical elements shape light received from the light source into an illumination field having a pattern selected from a circle, ring, rectangle, and a discontinuous pattern.

9. The illumination device of claim 1, wherein the light source is selected from the group consisting of an optical fiber, laser, diode laser, light-emitting diode, organic light-emitting diode, and incandescent lamp, or combinations thereof.

10. The illumination device of claim 1, wherein the light source is an ultraviolet light source.

11. The illumination device of claim 1, further comprising:
a gripper movable under preprogrammed control for positioning an object within said illumination field.

12. The illumination device of claim 1, further comprising:
a beam splitter optically coupled to said one or more diffractive, holographic optical elements for folding light delivered to said target.

13. The illumination device of claim 1, wherein said one or more diffractive, holographic optical elements comprise a diffractive pattern formed on a first surface of a transmissive material a hologram pattern formed on a second surface of the transmissive material opposite the first surface.

14. The illumination device of claim 1, wherein said one or more diffractive, holographic optical elements comprise a diffractive pattern and a holographic pattern combined on a single surface of an optical material.

15. The illumination device of claim 14, wherein the optical material is a transmissive optical material.

16. The illumination device of claim 14, wherein the optical material is a reflective optical material.

17. The illumination device of claim 1, further comprising:
a sleeve retaining a one of said one or more diffractive, holographic optical elements at a first end thereof and adapted to receive said light source at a second end thereof opposite the first end.

18. The illumination device of claim 1, further comprising:
a computer-based information handling system for receiving image representations of the target object and a second object to be positioned relative to said target object;
a positioner coupled to the information handling system for moving the second object to a desired position relative to said target object based on said image representations.

19. A method for illuminating a desired portion of a target object to be illuminated, comprising:
providing a source of light;
arranging a diffractive, holographic optical element in an optical path between said source of light and said target;
said optical element configured to deliver a selected pattern of light to an illumination field at a selected working distance away from the combined holographic and diffractive optical element; and
positioning said target object in said illumination field at a distance approximately equal to said working distance.

20. The method of claim 19, further comprising:
positioning a second object to be positioned relative to the target object in said illumination field;
storing image representations of the target object and the second object in a computer-based information handling system;
repeating said positioning and storing until the second object achieves a desired position relative to said target object.

21. The method of claim 20, further comprising:
applying a photobonding material to one or both of the target and second objects;
photobonding the second object to the target objects after the second object achieves said desired position.

22. The method of claim 21, wherein light providing illumination for said positioning has the same wavelength as light used for said photobonding.
